(19) United States
(12) Patent Application Publication
(10) Pub. No.: US 2007/0237051 A1
(43) Pub. Date: Oct. 11, 2007

(54) Optical Recording Medium and Recording Method

(76) Inventor: Hiroshi Kawai, Kanagawa (JP)

Correspondence Address: TAIYO CORPORATION, 401 HOLLAND LANE, #407, ALEXANDRIA, VA, 22314, US

(21) Appl. No.: 11/632,766

(22) PCT Filed: Jul. 21, 2005
(86) PCT No.: PCT/JP05/13780

§ 371 Date: Jan. 18, 2007

(30) Foreign Application Priority Data
Jul. 23, 2004 (JP) 2004-216227

(51) Int. Cl. G11B 7/125

(52) U.S. Cl. 369/100

(57) ABSTRACT

The present invention provides an optical recording medium having on each side thereof a recording layer in which information is recorded by irradiating the medium with a laser beam. Each recording layer is given recording condition information regarding at least one recording condition for the recording layer. The recording condition information given to one of the recording layers is different from that given to the other. The present invention also provides a recording method for the optical recording medium including: recording information in each of the recording layers on the basis of the at least one recording condition corresponding to the recording condition information given to the respective recording layer.

### TECHNICAL FIELD

The present invention relates to an optical recording medium which has a recording layer on each side thereof, and to a recording method for the same.

### BACKGROUND ART

Optical recording media (optical discs) where information is recorded only once by laser beam irradiation have been known. Such optical discs, called recordable CD's (so-called CD-R), typically have a recording layer containing an organic dye, a light-reflectance layer made of a metal such as gold, and a resin protective layer on a transparent disc-shaped substrate in that order. Information is recorded in the CD-R by irradiating the CD-R with laser beams having a wavelength in the near-infrared region (usually laser beams having a wavelength of around 780 nm). At this time, the irradiated areas of the recording layer absorb the beams, and the temperature of the recording layer locally increases, which changes a physical or chemical property of the recording layer (e.g., pit generation) and in turn an optical property of the recording layer. Thus, information can be recorded. On the other hand, the information is read (reproduced) by irradiating the CD-R with a laser beam having a wavelength the same as that of the laser beams for recording. More specifically, information is reproduced by detecting the difference in reflectance between areas where the optical property of the recording layer has been changed (recorded areas) and areas where the optical property is not changed (unrecorded areas).

In recent years, there is an increasing need for optical recording media having higher recording density. To satisfy the need, an optical disc called a recordable digital versatile disc (so-called DVD-R) has been proposed. The DVD-R has a structure in which two discs each having a recording layer containing a dye, and a light-reflectance layer, which is usually provided, and an optional protective layer on a transparent disc-shaped substrate with a guide groove (pre-groove) for tracking for an irradiated laser beam which guide groove has a track pitch (0.74 to 0.8 μm) no more than half of that of the guide groove of a CD-R are bonded to each other with an adhesive so that the recording layers are disposed inside. Alternatively, the DVD-R has another structure in which the above-described disc and a disc-shaped protective substrate having a shape the same as that of the disc are bonded to each other with an adhesive so that the recording layer is disposed inside. Information is recorded in the DVD-R and reproduced therefrom by irradiating the DVD-R with a visible laser beam (usually laser beam having a wavelength in the range of 630 to 680 nm), and the recording density of DVD-Rs can be higher than that of CD-Rs.

It is known that a label may be adhered onto the surface of an optical disc which surface is opposite the recording surface having recorded digital information or musical data. The label has printed visible image information such as the song title of the musical data recorded on the recording surface, and other titles for identifying the recorded data. Such optical discs are prepared by printing the title and other information on a circular label sheet with, for example, a printer, and then affixing the label sheet on the surface of each optical disc which surface is opposite the recording surface of the optical disc.

However, when producing an optical disc having a label side on which a desired visible image, such as a title or the like, is recorded, not only an optical disc drive but also a printer is required. Therefore, it is necessary to conduct a complex operation in which recording is performed in the recording side of the optical disc with the optical disc drive, the optical disc is then taken out from the optical disc drive, and a label sheet with information printed by a separate printer is attached to the optical disc.

Accordingly, an optical recording medium has been proposed, in which a display can be effected on the side opposite to the recording side by changing the contrast between the surface and the background with a laser beam (for example, see Japanese Patent Application Laid-Open (JP-A) Nos. 2003-272240 and 2004-5848). Here, ‘change’ means change which provides visible contrast, such as change in reflectance due to change in color, diffraction or scattering, or change in reflectance due to change in refractive index. By using such a medium, a desired image can be recorded on the label side of the optical disc by the optical disc drive without using a separate printer or the like.

In such an optical disc, recording (image forming) in the recording layers (code information recording layer and image information recording layer) on both sides is conducted with laser beams. Therefore, if the respective recording layers are not identified, erroneous recording, such as digital information (code information) being recorded in a recording layer in which an image is to be recorded, may occur. This problem may also occur in an optical disc having on both sides thereof recording layers in which code information is to be recorded and whose configurations or recording materials are different from each other.

Therefore, there is a need for an optical recording medium which has on each side thereof a recording layer and which enables desired information (e.g., an image) to be correctly recorded in each of the recording layers by laser beam irradiation, and a recording method for such an optical recording medium

### DISCLOSURE OF INVENTION

The invention provides an optical recording medium includes on each side thereof a recording layer in which recording is performed by irradiating the medium with a laser beam. Each recording layer is given recording condition information regarding at least one recording condition for that recording layer. The recording condition information given to one of the recording layers is different from that given to the other.

The invention also provides a recording method for the optical recording medium. The method includes recording information in each of the recording layers on the basis of the at least one recording condition corresponding to the recording condition information given to the respective recording layer.

The invention can provide an optical recording medium which has on each side thereof a recording layer and which enables desired information (e.g., an image) to be correctly recorded in each of the recording layers by laser beam irradiation, and a recording method for such an optical recording medium

### BEST MODE FOR CARRYING OUT THE INVENTION

An optical recording medium of the invention has on each side thereof a recording layer in which information is recorded by irradiating the medium with a laser beam. Each recording layer is given recording condition information regarding at least one recording condition for the recording layer. Further, the recording condition information given to one of the recording layers is different from that given to the other.

Hereinafter, the optical recording medium of the invention will be described in detail.

The optical recording medium of the invention may be a write-once type or a rewritable type optical recording medium, but is preferably a write-once type optical recording medium. In addition, the type of each recording layer is not particularly limited, and the recording layer is, for example, a phase-change type, a magneto-optical type, or a dye type one, and is preferably a dye type one.

Examples of the layer configuration of the optical recording medium may be described below.
(1) A first configuration in which a recording layer, a reflective layer, and a bonding layer are sequentially formed on a first substrate, and in which another recording layer and a second substrate are provided on the bonding layer
(2) A second configuration in which a recording layer, a reflective layer, a protective layer, and a bonding layer are sequentially formed on a first substrate, and in which another recording layer and a second substrate are provided on the bonding layer
(3) A third configuration in which a recording layer, a reflective layer, a protective layer, a bonding layer, and another protective layer are sequentially formed on a first substrate, and in which another recording layer and a second substrate are provided on the latter protective layer
(4) A fourth configuration in which a recording layer, a reflective layer, a protective layer, a bonding layer, another protective layer, and another reflective layer are sequentially formed on a first substrate, and in which another recording layer and a second substrate are provided on the latter reflective layer
(5) A fifth configuration in which a recording layer, a reflective layer, a bonding layer, and another reflective layer are sequentially formed on a first substrate, and in which another recording layer and a second substrate are provided on the latter reflective layer
(6) A sixth configuration in which a recording layer, a reflective layer, and a protective layer are sequentially formed on a first substrate, and in which another protective layer, another reflective layer, another recording layer, and a second substrate are provided on the protective layer

These layer configurations (1) to (6) are simply exemplified. The layer configuration of the optical recording medium of the invention is not limited to the configurations and the order of the layers described above may be changed. Further, one or more of the layers may be omitted. In addition, each of the above-described layers may be composed of a single layer or a plurality of layers. The first and second substrates may be generically called substrates in the following descriptions.

In addition, each of the recording layers of the above-described configurations may be a code information recording layer in which code information is recorded or an image information recording layer in which visible image information is recorded. Specifically, one of the recording layers of the optical recording medium may be a code information recording layer and the other may be an image information recording layer. Alternatively, both may be the code information recording layers.

Hereinafter, the substrates and the respective layers will be described in detail.

<Recording Layer>

As described above, each of the recording layers of the optical recording medium of the invention is a code information recording layer or an image information recording layer. First, the code information recording layer will be described in detail.

[Code Information Recording Layer]

The code information recording layer is a layer in which code information such as digital information is recorded. Examples thereof include dye type, write-once type, phase-change type, and magneto-optical type recording layers. The type of the code information recording layer is not particularly limited, but the code information recording layer is preferably a dye type one.

Typical examples of the dye contained in the dye-type code information recording layer include cyanine dyes, oxonol dyes, metal complex dyes, azo dyes, and phthalocyanine dyes.

Further, those disclosed in JP-A Nos. 4-74690, 8-127174, 11-53758, 11-334204, 11-334205, 11-334206, 11-334207, 2000-43423, 2000-108513, and 2000-158818 can be preferably used.

In addition, the recording material of the recording layer is not limited to the dye. For example, the recording material is preferably an organic compound, such as a triazole compound, a triazine compound, a cyanine compound, a merocyanine compound, an aminobutadiene compound, a phthalocyanine compound, a cinnanic acid compound, a viologen compound, an azo compound, an oxonol benzooxazole compound, or a benzotriazole compound. Among these compounds, a cyanine compound, an aminobutadiene compound, a benzotriazole compound, or a phthalocyanine compound is particularly preferably used.

The code information recording layer may be formed in accordance with any of deposition, sputtering, chemical vapor deposition (CVD), and coating, but is preferably formed by coating. In the case of coating, a coating solution is prepared by dissolving a dye, an optional quencher, and an optional binder in a solvent, and the coating solution is applied to the surface of a substrate to form a coating film, and the coating film is dried. The concentration of the recording material in the coating solution is generally in the range of from 0.01 to 15% by mass, preferably in the range of from 0.1 to 10% by mass, more preferably in the range of from 0.5 to 5% by mass, and most preferably in the range of from 0.5 to 3% by mass.

Examples of the solvent for the coating solution include: esters, such as butyl acetate, ethyl lactate, and cellosolve acetate; ketones, such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as dibutyl ether, diethyl ether, tetrahydrofuran, and dioxane; alcohols such as ethanol, n-propanol, iso-propanol, n-butanol, and diacetone alcohol; fluorinated solvents such as 2,2,3,3-tetrafluoropropanol; and glycol ethers such as ethylene glycol monomethyl ether, ethylene glycol monoethyl ether, and propylene glycol monomethyl ether.

Considering the solubility of the dye used, one of the solvents described above may be used alone or two or more of them can be used together. The coating solution may further contain at least one additive such as an antioxidant, a UV absorbent, a plasticizer, or a lubricant according to the intended use.

When the coating solution contains a binder, examples of the binder include natural organic polymer materials, such as gelatin, cellulose derivatives, dextran, rosin, and rubber; and synthetic organic polymers including hydrocarbon resins, such as polyethylene, polypropylene, polystyrene, and polyisobutylene, vinyl resins, such as polyvinyl chloride, polyvinylidene chloride, vinyl chloride/vinyl acetate copolymer, acryl resins, such as polymethyl acrylate, and polymethyl methacrylate, polyvinyl alcohol, chlorinated polyethylene, epoxy resins, butyral resins, rubber derivatives, and initial condensation products of thermosetting resins, such as phenol/formaldehyde resins.

When the code information recording layer contains a binder, the content of the binder is generally 0.01 to 50 times, and preferably 0.1 to 5 times as much as the mass of the dye.

The coating method for the coating solution may be a spray method, a spin coating method, a dip method, a roll coating method, a blade coating method, a doctor roll method, or a screen printing method. The code information recording layer may be composed of a single layer or a plurality of layers. The thickness of the code information recording layer is generally 10 to 500 nm, preferably 15 to 300 nm, and more preferably 20 to 150 nm.

The recording layer may contain any discoloration inhibitor for improvement in light fastness of the recording layer. A singlet-oxygen quencher is generally used as the discoloration inhibitor. Any known singlet oxygen quencher described in literature, including patent specifications, may be used. Typical examples thereof include those described in JP-A Nos. 58-175693, 59-31194, 60-18387, 60-19586, 60-19587, 60-35054, 60-36190, 60-36191, 60-44554, 60-44555, 60-44389, 60-44390, 60-54892, 60-47069, 68-209995, and 4-25492, Japanese Patent Application Publication (JP-B) Nos. 1-38680 and 6-26028, German Patent. No. 350399, and Nippon Kagakukaishi JP, October 1992, p. 1141.

The content of the discoloration inhibitor such as the singlet oxygen quencher is usually in the range of 0.1 to 50% by mass, preferably in the range of 0.5 to 45% by mass, more preferably in the range of 3 to 40% by mass, and still more preferably in the range of 5 to 25% by mass relative to the mass of the dye.

Typical examples of the material of the phase-change recording layer include: Sb—Te alloy, Ge—Sb—Te alloy, Pd—Ge—Sb—Te alloy, Nb—Ge—Sb—Te alloy, Pd—Nb—Ge—Sb—Te alloy, Pt—Ge—Sb—Te alloy, Co—Ge—Sb—Te alloy, In—Sb—Te alloy, Ag—In—Sb—Te alloy, Ag—V—In—Sb—Te alloy, and Ag—Ge—In—Sb—Te alloy. The material is preferably Ge—Sb—Te or Ag—In—Sb—Te alloy among them, since such an alloy enables rewriting a great number of times.

The thickness of the phase-change recording layer is preferably 10 to 50 nm, and more preferably 15 to 30 nm.

The phase-change type code information recording layer may be formed in accordance with a gas phase thin film deposition method such as a sputtering method, or a vacuum deposition method.

[Image Information Recording Layer]

Next, the image information recording layer will be described in detail. Visible image information (visual information), such as a character, a figure, a picture, or a pattern, which a user desires, is recorded in the image information recording layer. The visible image information means image information that can be visually recognized and includes all types of visible information, such as a character (string), a picture, a pattern, and a figure. Examples of the image information include the title of the disc, content information, the thumbnail of the content, related picture, design, copy right information, recording date and time, recording method, and recording format.

Examples of the character information include authorized user—designation information, expiration date information, information regarding designated allowable number of times of use, rental information, resolution-specifying information, layer-specifying information, user-specifying information, copyright holder information, copyright number information, manufacturer information, production date information, sales date information, dealer or seller information, usage set-number information, designated area information, language-specifying information, application-specifying information, product user information, and usage number information.

Visible image information such as a character, an image, a picture, or a pattern is recorded in the image information recording layer by irradiating the optical recording medium with a laser beam. The material(s) of the image information recording layer can include a dye the same as any of those described in the explanations for the code information recording layer.

In the optical recording medium of the invention, the ingredient(s) of the code information recording layer (dye or phase-change recording material) and the ingredient(s) of the image information recording layer may be the same or different. However, since characteristics required for the code information recording layer are different from those required for the image information recording layer, it is preferable that the ingredients of them are different. Specifically, it is preferable that the ingredient(s) of the code information recording layer has superior recording/reproducing characteristics and that the ingredient(s) of the image information recording layer provides a recorded image with high contrast. In particular, when the image information recording layer includes a dye, the dye is preferably a cyanine dye, a phthalocyanine dye, an azo dye, an azo metal complex dye, or an oxonol dye among the above-described dyes from the viewpoint of improved contrast of a recorded image.

Further, one of the code information recording layer and the image information recording layer may be a phase-change type one and the other may be a dye type one. In this case, it is preferable that the code information recording layer is a phase-change type one and that the image information recording layer is a dye type one.

The image information recording layer can be formed by dissolving a dye in a solvent, and applying the resultant coating solution to the surface of a substrate. The solvent may be the same as that contained in the coating solution for the code information recording layer. Additives, the coating method, and the like may be the same as those for the code information recording layer.

The thickness of the image information recording layer is preferably from 0.01 to 200 μm, more preferably from 0.05 to 100 μm, and still more preferably from 0.1 to 50 μm.

In the optical recoding medium of the invention, each recording layer (code information recording layer or image information recording layer) is given recording condition information regarding at least one recording condition for the respective recording layer. Moreover, the recording condition information given to one of the recording layers is different from that given to the other.

The recording condition information is related to at least one recording condition for the corresponding recording layer and is registered in land pre-pit(s) (LPP). For example, the recording condition information can include a manufacture code, recording strategy information, and/or the highest recording speed information. The recording condition information preferably includes a manufacture code and recording strategy information among these, since existent information can be used as it is. Manufacturers (and in turn products) have different manufacture codes, each of which includes, for example, information representing a manufacturer.

Recording strategy information is used to realize optimum recording in the optical recording medium to which the recording strategy information is given. Here, optical recording media manufactured by various manufacturers have somewhat different types of optimum recording strategy.

Manufacturers of optical recording media such as DVD-Rs supply one or more kinds of media based on their own technologies. Then, the optimum recording strategy to realize optimum recording in a certain type of optical recording medium is slightly different from those for other types of optical recording media, as described above. Therefore, in order to overcome the difference in recording strategy between optical recording media and to enable recording according to optimum recording strategy corresponding to each optical recording medium, manufacturers of recording devices provide recording devices having a reader, a built-in operation software (so-called firmware), a controller and a recording unit. Optimum recording strategy corresponding to each of optical recording media and a plurality of characteristic parameters of the recording device are stored in the firmware. Each optimum recording strategy is associated with some or all of the characteristic parameters. The reader reads the recording condition information of an optical recording medium in which information is to be recorded. The controller reads out characteristic parameters corresponding to the read recording condition information from the firmware, and drives the recording unit according to the read characteristic parameters. Therefore, optimum recording can be conducted in the optical recording medium according to the recording strategy corresponding to the optical recording medium.

Each recording layer has at least one recording condition suitable for the characteristics of the recording layer. Examples of the recording condition(s) include at least one recording condition suitable for a code information recording layer, at least one recording condition suitable for an image information recording layer, at least one recording condition for each manufacturer, at least one recording condition for each product, and at least one recording condition for each recording speed.

The optical recording medium of the invention is used together with the following recording device. The recording device has a memory storing a table in which various recording conditions are tabulated. The recording conditions include at least one recording condition suitable for the configuration of each recording layer, that for each manufacturer, and that for each product. In addition, the recording device identifies the type of an optical recording medium in which information is to be recorded, reads out at least one recording condition corresponding to the identified type of the optical recording medium from the memory, and records information according to the read recording condition(s).

When the optical recording medium of the invention has, for example, a code information recording layer on one side thereof and an image information recording layer on the other side thereof, the recording condition information given to the code information recording layer is different from that given to the image information recording layer. Specifically, the recording condition information of the code information recording layer is related to the recording condition(s) of the code information recording layer and the recording condition information of the image information recording layer is related to the recording condition(s) of the image information recording layer. As a result, erroneous recording such as code information being erroneously recorded in the image information recording layer can be prevented. In other words, information can be recorded in the proper recording layer.

The optical recording medium of the invention may have a code information recording layer on each side thereof. In this case, the code information recording layers formed on both sides may have different structures and/or may contain different recording materials. When the configurations of the code information recording layers are different, the code information recording layers may be dye type layers or phase-change type layers having different recording speeds. When the code information recording layers contain different recording materials, one of the recording layers may be a dye type one and the other may be a phase-change type one. In any case, the recording condition information given to one of the code information recording layers is different from that given to the other.

When the optical recording medium of the invention has, for example, a first code information recording layer adaptable for single to quad speed on one side thereof and a second code information recording layer adaptable for quad to sixteenfold speed on the other side thereof, the recording condition information given to the first code information recording layer corresponds to the recording speed of the first code information recording layer, and the recording condition information given to the second code information recording layer corresponds to the recording speed of the second code information recording layer and is different form that given to the first code information recording layer. In other words, the recording condition information given to the first code information recording layer is related to at least one recording condition adaptable for single to quad speed, and the recording condition information given to the second code information recording layer is related to at least one recording condition adaptable for quad to sixteenfold speed. As a result, erroneous recording can be prevented and recording suitable for each of the recording speeds can be therefore performed.

Further, when the optical recording medium of the invention has a dye type code information recording layer on one side thereof and a phase-change type code information recording layer on the other side thereof, the recording condition information given to the dye type code information recording layer is different from that given to the phase-change type code information recording layer. Specifically, the recording condition information given to the dye type code information recording layer is correlated with the recording condition(s) of the dye-type recording layer and the recording condition information given to the phase-change type code information recording layer is correlated with the recording condition(s) of the phase-change type recording layer. As a result, erroneous recording can be prevented and recording suitable for each of the code information recording layers can be therefore performed.

In the optical recording medium of the invention, which can be any of the above-described types, information is recorded in the proper recording layer on the basis of the recording condition information given to that recording layer, so that erroneous recording can be prevented and desired information (e.g., an image) can be correctly recorded in the corresponding recording layer. Further, optimum recording can be performed according to the characteristics of each of the recording layers.

[Substrates (First and Second Substrates)]

Each of the substrates for the optical recording medium of the invention may be made of any material used as the material of the substrate for conventional optical recording media.

Examples of the material include glass, polycarbonate, acrylic resins such as polymethyl methacrylate, vinyl chloride resins such as polyvinyl chloride and copolymers whose monomers include vinyl chloride, epoxy resins, amorphous polyolefins and polyesters. Two or more of these resins may be used together, if desired.

The substrates made of these materials may be used as films or rigid plates. The material of the substrate is preferably polycarbonate because of its good moisture resistance, good dimensional stability, and low cost.

The thickness of the substrate is preferably from 0.1 to 1.2 mm and more preferably from 0.2 to 1.1 mm. The substrate preferably has a groove having a track pitch narrower than that of the groove formed on the substrate(s) of conventional CD-Rs or DVD-Rs to increase recording density. In this case, the track pitch of the groove is preferably in the range of 200 to 400 μm and more preferably in the range of 250 to 350 nm. The depth of the groove is preferably in the range of 20 to 150 nm and more preferably in the range of 50 to 100 nm.

In addition, the width of the groove is preferably in the range of 50 to 250 nm and more preferably in the range of 100 to 200 nm. The tilt angle of the groove is preferably in the range of 20 to 80° and more preferably in the range of 30 to 70°.

An undercoat layer is preferably provided between the surface of the substrate (the surface on which the groove is formed) and a recording layer to improve smoothness of a surface on which the recording layer is to be formed and adhesion between the substrate and the recording layer and to prevent the recording layer from deteriorating.

Examples of the material for the undercoat layer include high-molecular-weight materials, such as polymethyl methacrylate, acrylic acid/methacrylic acid copolymer, styrene/maleic anhydride copolymer, polyvinyl alcohol, N-methylolacrylamide, styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, polyethylene, polypropylene, and polycarbonate; and surface-modifying agents, such as silan coupling agents. The undercoat layer can be formed by dissolving or dispersing the above-described material in a suitable solvent, and applying the resultant coating solution or dispersion to the surface of a substrate in accordance with, for example, a spin coating method, a dip coating method, or an extrusion coating method.

The thickness of the undercoat layer is generally in the range of from 0.005 to 20 μm, and preferably in the range of from 0.01 to 10 μm.

[Reflective Layer]

For the purpose of improving reflectance when reproducing information, a reflective layer adjacent to the recording layer is provided. A light reflective material, which is the material of the reflective layer, has high reflectance with respect to laser beams. Examples thereof include metals, such as magnesium, selenium, yttrium, titanium, zirconium, hafnium, vanadium, niobium, tantalum, chromium, molybdenum, tungsten, manganese, rhenium, iron, cobalt, nickel, ruthenium, rhodium, palladium, iridium, platinum, copper, silver, gold, zinc, cadmium, aluminum, gallium, indium, silicon, germanium, tellurium, lead, polonium, tin, and bismuth, semimetals, and stainless steel. One of these materials may be used alone, or two or more of them can be used together or can be used as an alloy. The material is preferably chromium, nickel, platinum, copper, silver, gold, aluminum, stainless steel or an alloy thereof among these. The material is more preferably gold, silver, aluminum, or an alloy thereof, and most preferably silver, aluminum, or an alloy thereof. The reflective layer may be formed by depositing, sputtering or ion-plating the light reflective material on the substrate or recording layer. The thickness of the reflective layer is generally in the range of from 10 to 300 nm, and preferably in the range of from 50 to 200 nm.

[Bonding Layer]

The bonding layer is an optionally-provided layer to improve adhesion between the reflective layer and the substrate (second substrate).

The material of the bonding layer is preferably a photo-curable resin, and, in order to prevent the disc from warping, is more preferably a photo-curable resin having a small shrinkage rate at the time of curing. Such a photo-curable resin can be, for example, an ultraviolet curable resin (ultraviolet curable adhesive) such as SD-640™ and SD-347™ manufactured by Dainippon Ink and Chemicals, Incorporated. The thickness of the bonding layer is preferably from 1 to 1000 μm, more preferably from 5 to 500 μm, and still more preferably from 10 to 100 μm so as to obtain elasticity.

The second substrate (protective substrate) can be made of a material the same as that of the first substrate.

Hereinafter, an optional protective layer will be described in detail.

[Protective Layer]

For the purpose of physically and chemically protecting the reflective layer or the recording layer, the protective layer may be provided.

When the optical recording medium of the invention has a structure similar to that of a DVD-R type optical recording medium, and, in other words, when the two substrates of the optical recording medium, one of which may be a dummy substrate, are bonded to each other with recording layers disposed inside, the optical recording medium does not necessarily have a protective layer.

Examples of the material of the protective layer include inorganic materials such as ZnS, ZnS—SiO₂, SiO, SiO₂, MgF₂, SnO₂ and Si₃N₄, and organic materials such as thermoplastic resins, thermosetting resins and ultraviolet curable resins. The protective layer may be formed by laminating a film obtained by extrusion-processing plastic, on the reflective layer with an adhesive. Alternatively, the protective layer may be formed by a vacuum deposition method, a sputtering method, or a coating method.

Alternatively, when the protective layer is made of a thermoplastic or thermosetting resin, the layer can be formed by dissolving the resin in a suitable solvent, applying the resultant coating solution, and drying the coated film. When the protective layer is made of a UV-curable resin, the layer may be formed by applying the coating solution of the resin, and irradiating the coated film with UV rays to cure the film. The coating solution may further contain at least one additive such as an antistatic agent, an antioxidant, and/or a UV absorbent according to the intended use. The thickness of the protective layer is generally in the range of 0.1 μm to 1 mm.

[Recording Method]

The recording method of the invention is conducted to record information in of the optical recording medium of the invention. Here, information is recorded in each of the recording layers on the basis of the at least one recording condition corresponding to the recording condition information given to the respective recording layer. The optical recording medium of the invention may have a configuration in which a recording layer on one side thereof is a code information recording layer and in which a recording layer on the other side is an image information recording layer, or a configuration in which recording layers on both sides thereof are code information recording layers. First, the recording method of the invention in which information is recorded in the optical recording medium of the invention having a code information recording layer on one side thereof and an image information recording layer on the other side will be described in detail.

In the recording method of the invention, recording image information in the image information recording layer of the optical recording medium and recording code information in the code information recording layer may be performed with an optical disc drive (recording device) having a function for recording image information in the image information recording layer and for recording code information in the code information recording layer, or may be separately performed with a recording device for exclusively recording code information in the code information recording layer and a recording device for exclusively recording image information in the image information recording layer. In these recording methods, recording can be performed in one of the image information recording layer and the code information recording layer, and the optical recording medium is reversed, and recording can be performed in the other recording layer. An optical disc drive having a function for recording a visible image in an image information recording layer is disclosed in, for example, JP-A Nos. 2003-203348 and 2003-242750.

The recording device used in the recording method of the invention has not only a recording unit for recording information in a recording layer, but also a reader for reading recording condition information (manufacture code and recording strategy information) previously recorded on an optical recording medium with a laser beam, a memory that stores at least one recording condition corresponding to each recording condition information, and a controller which reads out at least one recording condition corresponding to the read recording condition information from the memory and which instructs the recording unit to record information on the basis of the read at least one recording condition. In such a recording device, information is recorded as follows. The recording device reads recording condition information recorded on an optical recording medium in which information is to be recorded. Thereafter, the recording device reads out at least one recording condition corresponding to the read recording condition information from the memory.

When the read recording condition information corresponds to an image information recording layer, a visible image is recorded in the image information recording layer according to the read at least one recording condition. Specifically, the visible image is recorded in the image information recording layer by relatively moving the optical recording medium and a laser pickup unit along the surface of the optical recording medium in the radial direction, modulating a laser beam according to image data, such as a character and/or a picture to be imaged, and irradiating the modulated laser beam toward the image information recording layer. Here, the modulation and irradiation is synchronized with the relative movement. The configuration of such a recording device for recording a visible image is disclosed, for example, in JP-A No. 2002-203321.

On the other hand, when the read recording condition information corresponds to a code information recording layer, code information is recorded in the code information recording layer according to the read at least one recording condition. In recording the code information in the code information recording layer, the laser pickup unit of the recording device irradiates a laser beam toward the code information recording layer of the optical recording medium, which is being rotated. In reproducing the recorded information, a similar operation is conducted. The configuration of such a recording device for recording code information is well known.

The recording waveform of a laser beam used to form one pit may be one pulse or a pulse train. The ratio of the width of the pulse or pulse train to the actual length of a pit to be recorded is important.

The ratio of the width of the pulse to the actual length of a pit to be recorded is preferably 20 to 95%, more preferably 30 to 90%, and still more preferably 35 to 85%. When the pulse waveform is a pulse train, the ratio of the total width of the pulse train to the actual length of a pit to be recorded is within the above-described ranges.

The power of the laser beam depends on recording linear velocity. When the recording linear velocity is 3.5 m/s, the power of the laser beam is preferably from 1 to 100 mW, more preferably from 3 to 50 mW, and still more preferably from 5 to 20 mW. When the recording linear velocity is doubled, the power of the laser beam is preferably in the range, each of the upper and lower limits of which is 2^{1/2} times as large as the corresponding limit of each of the above ranges.

In order to increase recording density, the numerical aperture (NA) of an objective lens is preferably at least 0.55, and more preferably at least 0.60.

In the invention, a semiconductor laser having an oscillation wavelength ranging from 350 to 850 nm may be used as the recording unit.

Next, the recording method for an optical recording media having a phase-change code information recording layer will be generally described. The phase-change layer is made of the aforementioned material and can repeat phase change between a crystalline phase and an amorphous phase by laser beam irradiation.

In recording information, the phase-change recording layer is locally melted by irradiating the layer with at least one focused laser beam pulse for a short period of time. The melted area is rapidly cooled and solidified by heat diffusion, becoming a recording mark which is an amorphous phase. In order to erase the recorded information, the recording mark is irradiated with a laser beam, heated to a temperature which is no more than the melting point of the code information recording layer but which is no less than the crystallization temperature of the recording layer, and gradually cooled to recrystallize the recording mark into the original unrecorded state (crystalline phase).

Next, the recording method for the optical recording medium of the invention having code information recording layers on both sides thereof will be described. In this embodiment, code information recording layers provided on both sides have different configurations or contain different recording materials, as described previously. When the configurations are different, both the recording layers may be dye type or phase-change type layers having different recoding speeds. When the recording materials are different, one of the recording layers may be a dye type one and the other may be a phase-change type one. In these cases, recording condition information given to one of the recording layers is different from that given to the other, and recording is performed in each of the code information recording layers according to at least one recording condition corresponding to the recording condition information given to the respective layer, as in the recording method for an optical recording medium having a code information recording layer on one side thereof and an image information recording layer on the other side thereof.

As described above, according to the recording method of the invention, recording is performed in the respective recording layers based on the recording condition information. Therefore, erroneous recording can be prevented and desired information (e.g., an image) can be correctly recorded in each of the recording layers. Further, optimum recording can be performed according to the characteristics of each recording layer.

### EXAMPLES

Next, examples of the invention will be described in detail, but the invention is not limited to the examples.

### Example 1

Example 1 relates to a DVD-R type optical recording medium obtained by bonding two discs. Hereinafter, a method for manufacturing such an optical recording medium will be described.

First, a substrate made of a polycarbonate resin, and having a spiral groove (depth of 130 nm, width of 300 nm, and track pitch of 0.74 μm), a thickness of 0.6 mm, and a diameter of 120 mm was prepared by injection molding. 0.75 g of the following pigment A and 0.50 g of the following pigment B were dissolved in 100 ml of 2,2,3,3-tetrafluoro-1-propanol, and the resultant coating solution (1) was applied to the surface of the substrate on which surface the groove was formed in accordance with a spin coating method. A code information recording layer was thus formed. Next, a reflective layer having a thickness of 120 nm was formed by sputtering silver on the code information recording layer. Thereafter, an ultraviolet curable resin (SD318 manufactured by Dainippon Ink and Chemicals, Incorporated) was applied to the reflective layer in accordance with a spin coating method. Then, the resultant resin layer was irradiated with ultraviolet rays to cure the ultraviolet curable resin. A protective layer having a thickness of 10 μm was thus formed. Through the above-described processes, a first disc was manufactured.

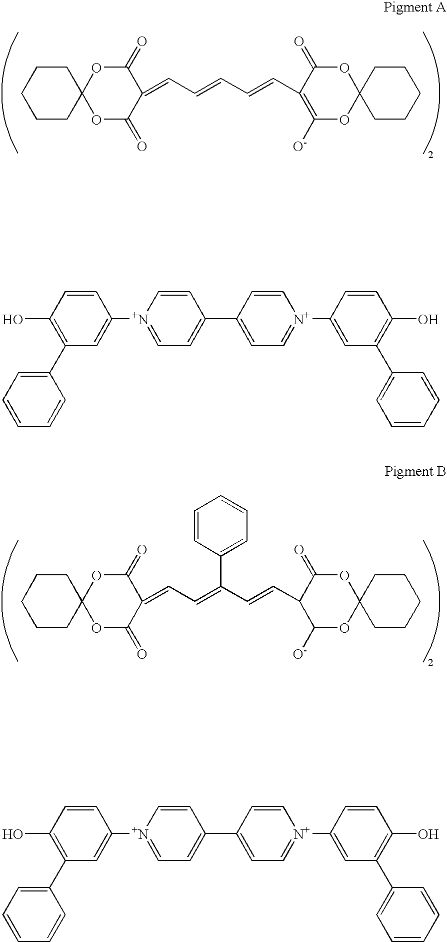

Next, 0.75 g of pigment A and 0.50 g of the following pigment C were dissolved in 100 ml of 2,2,3,3-tetrafluoro-1-propanol, and the resultant coating solution (2) was applied to the surface of another substrate having a thickness of 0.6 mm, a diameter of 120 mm, and a spiral groove for tracking (depth of 130 nm, width of 300 nm, and pitch of 0.74 μm) in accordance with a spin coating method. An image information recording layer was thus formed. Next, a reflective layer having a thickness of 120 nm was formed by sputtering silver on the image information recording layer, and an ultraviolet curable resin (SD318 manufactured by Dainippon Ink and Chemicals, Incorporated) was applied to the reflective layer in accordance with a spin coating method. Then, the resultant resin layer was irradiated with ultraviolet rays to cure the ultraviolet curable resin. A protective layer having a thickness of 10 μm was thus formed. Through the above-described processes, a second disc was manufactured. Here, registration information (manufacture code) of land pre-pit (LPP) registered in the second disc was different from information (manufacture code) registered in the first disc.

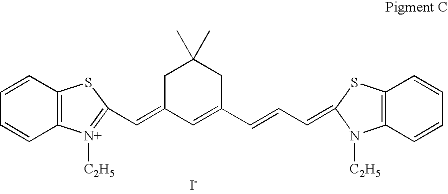

Subsequently, an optical disc was prepared by bonding the first disc and the second disc in the following steps. First, a slow-acting cationic polymerization adhesive (SDK7000 manufactured by Sony Chemicals Corp.) was applied to the protective layers of the two discs by screen printing. The printing plate used in the screen printing had a mesh size of 300 meshes. Immediately after the resultant printed layers were irradiated with ultraviolet rays from a metal halide lamp, the protective layers of the first and second discs were bonded, and pressure was applied to each surface of the resulting disc for five minutes. As described above, an optical recording medium of Example 1 was thus prepared.

### Comparative Example 1

An optical recording medium of Comparative Example 1 was prepared in the same manner as in Example 1, except that the second disc was replaced with the first disc. That is, the optical recording medium of Comparative Example 1 was prepared by bonding two first discs, and thus had code information recording layers having the same manufacture code on both sides thereof.

Evaluation

A disc drive device which was the same as a disc drive device (DDU 1000 manufactured by Pulstec Industrial, Co., Ltd.) except that it had remodeled firmware was used to record information in each of these optical recording media. Specifically, the manufacture codes of the code information recording layer(s) and the image information recording layer and at least one recording condition corresponding to each of the manufacture codes (that is, at least one condition for optimum recording with respect to each of the code information recording layer(s) and the image information recording layer) were recorded as a table in the firmware. In the disc drive device, the manufacture code of LPP(s) of each recording layer was read, and at least one recording condition corresponding to the read manufacture code was read out from the firmware.

An image was recorded in the image information recording layer of the optical recording medium of Example 1 with the disc drive device. Moreover, an attempt to erroneously record an image in the code information recording layers of the optical recording medium of Comparative Example 1 with the disc drive device was made. Quality of each recorded image was evaluated with naked eyes. In addition, a check was made to determine whether information to be recorded in a code information recording layer was erroneously recorded in the image information recording layer.

TABLE 1

| | | Erroneous Recording in Image |
|---|---|---|
| | Visual Image Evaluation | Information Recording Layer |
| Example 1 | Good | Absence |
| Comparative | Bad | Presence |
| Example 1 | | |

Table 1 shows that, in Comparative Example 1, the manufacture code was improper, and that thus the image quality was bad, and that erroneous recording occurred in the image information recording layer. Table 1 also shows that, in Example 1, the image quality was good and that erroneous recording did not occur in the image information recording layer.

1. An optical recording medium comprising on each side thereof a recording layer in which information is recorded by irradiating the optical recording medium with a laser beam;
wherein each recording layer is given recording condition information regarding at least one recording condition for the recording layer, and recording condition information given to one of the recording layers is different from that given to the other.

2. The optical recording medium according to claim 1,
wherein the recording condition information is manufacture code information and/or recording strategy information.

3. The optical recording medium according to claim 1,
wherein one of the recording layers is a code information recording layer in which code information is recorded, and the other is an image information recording layer on which visible image information is recorded.

4. The optical recording medium according to claim 2,
wherein one of the recording layers is a code information recording layer in which code information is recorded, and the other is an image information recording layer on which visible image information is recorded.

5. The optical recording medium according to claim 1,
wherein the recording layers are code information recording layers in each of which code information is recorded.

6. The optical recording medium according to claim 2,
wherein the recording layers are code information recording layers in each of which code information is recorded.

7. The optical recording medium according to claim 5,
wherein the configurations or recording materials of the code information recording layers are different.

8. The optical recording medium according to claim 6,
wherein the configurations or recording materials of the code information recording layers are different.

9. A recording method for an optical recording medium, which is the optical recording medium according to claim 1, the recording method comprising:
recording information in each of the recording layers on the basis of the at least one recording condition corresponding to the recording condition information given to the respective recording layer.

10. The recording method according to claim 9,
wherein the recording condition information is manufacture code information and/or recording strategy information.

11. The recording method according to claim 9,
wherein one of the recording layers is a code information recording layer in which code information is recorded, and the other is an image information recording layer in which visible image information is recorded.

12. The recording method according to claim 10,
wherein one of the recording layers is a code information recording layer in which code information is recorded, and the other is an image information recording layer in which visible image information is recorded.

13. The recording method according to claim 9,
wherein the recording layers are code information recording layers in each of which code information is recorded.

14. The recording method according to claim 10,
wherein the recording layers are code information recording layers in each of which code information is recorded.

15. The recording method according to claim 13,
wherein the configurations or recording materials of the code information recording layers are different.

16. The recording method according to claim 14,
wherein the configurations or recording materials of the code information recording layers are different.
